(19) United States
(12) Patent Application Publication
(10) Pub. No.: US 2026/0032635 A1
(43) Pub. Date: Jan. 29, 2026

(54) INFORMATION PROCESSING DEVICE, INFORMATION PROCESSING PROGRAM, AND INFORMATION PROCESSING METHOD

(71) Applicant: SONY GROUP CORPORATION, TOKYO (JP)

(72) Inventors: YASUNORI AOKI, TOKYO (JP); HIROYUKI KAMATA, TOKYO (JP); TAKAHIRO TSUJII, TOKYO (JP); KENEI MATSUDAIRA, TOKYO (JP)

(21) Appl. No.: 18/997,296

(22) PCT Filed: Jun. 9, 2023
(86) PCT No.: PCT/JP2023/021522

§ 371 Date: Jan. 21, 2025

(30) Foreign Application Priority Data
Aug. 3, 2022 (JP) 2022-124161

(51) Int. Cl. H04W 64/00; H04W 4/38

(52) U.S. Cl. CPC H04W 64/006; H04W 4/38

(57) ABSTRACT

A new and improved technology capable of performing indoor positioning with higher accuracy is provided.

An information processing device is provided that includes: an acquisition unit configured to acquire position information of a user terminal estimated on the basis of sensing data acquired by the user terminal used by a user and a content operation history of the user recognized by an action recognition unit; and a position information correction unit configured to correct the estimated position information of the user terminal on the basis of position information of the user terminal and the content operation history of the user.

### TECHNICAL FIELD

The present disclosure relates to an information processing device, an information processing program, and an information processing method.

### BACKGROUND ART

In recent years, various techniques for acquiring position information of an information processing terminal such as a smartphone have been studied. A typical example of the positioning technology for an information processing terminal is a global navigation satellite system (GNSS). Since the GNSS estimates position information on the basis of radio waves received from an artificial satellite, it is difficult to perform positioning with high accuracy indoors where radio waves from the satellite are blocked. Therefore, there is a demand for a technique for acquiring position information indoors with high accuracy. For example, Patent Document 1 discloses a system that performs indoor positioning on the basis of indoor sensing data and uses a positioning result for action analysis.

### CITATION LIST

### Patent Document

Patent Document 1: Japanese Patent Application Laid-Open No. 2022-002030

### SUMMARY OF THE INVENTION

### Problems to be Solved by the Invention

However, a technology capable of performing indoor positioning with higher accuracy is desired.

Therefore, the present disclosure provides a new and improved technology capable of performing indoor positioning with higher accuracy.

### Solutions to Problems

According to the present disclosure, an information processing device is provided that includes: an acquisition unit configured to acquire position information of a user terminal estimated on the basis of sensing data acquired by the user terminal used by a user and a content operation history of the user recognized by an action recognition unit; and a position information correction unit configured to correct the estimated position information of the user terminal on the basis of position information of the user terminal and the content operation history of the user.

Also, according to the present disclosure, an information processing method to be executed by a computer is provided that includes: acquiring position information of a user terminal estimated on the basis of sensing data acquired by the user terminal used by a user and a content operation history of the user recognized by an action recognition unit; and correcting the estimated position information of the user terminal on the basis of position information of the user terminal and the content operation history of the user.

Furthermore, according to the present disclosure, a program is provided that causes a computer to function as: an acquisition unit configured to acquire position information of a user terminal estimated on the basis of sensing data acquired by the user terminal used by a user and a content operation history of the user recognized by an action recognition unit; and a position information correction unit configured to correct the estimated position information of the user terminal on the basis of position information of the user terminal and the content operation history of the user.

### BRIEF DESCRIPTION OF DRAWINGS

FIG. 1 is an explanatory diagram explaining an outline of an information processing system according to an embodiment of the present disclosure.

FIG. 2 is an explanatory diagram for explaining correction of position information performed by a device 20.

FIG. 3 is a block diagram for explaining an example of a functional configuration of a server 10 according to the present embodiment.

FIG. 4 is a block diagram for explaining an example of a functional configuration of a device 20 according to the present embodiment.

FIG. 5 is an explanatory diagram for explaining an example of content identification information, coordinates, and reliability information stored in a storage unit 230.

FIG. 6 is an explanatory diagram for explaining a position change of the device 20 before correction estimated by a position estimation unit 270.

FIG. 7 is an explanatory diagram for explaining processing of correcting estimated position information by a position information correction unit 293.

FIG. 8 is a conceptual drawing of a map of a museum illustrating a work position corresponding to each content for explaining a content list screen generated by a generation unit 295.

FIG. 9 is an explanatory diagram for explaining an example of a content list screen generated by the generation unit 295.

FIG. 10 is an explanatory diagram for explaining an example of a content list screen generated by the generation unit 295.

FIG. 11 is a flowchart for explaining an operation example of the device 20 according to the present embodiment.

FIG. 12 is a block diagram for explaining a functional configuration example of a device 21 according to a first modification of an information processing system of the present embodiment.

FIG. 13 is a block diagram for explaining a functional configuration example of a server 12 according to a second modification of an information processing system of the present embodiment.

FIG. 14 is a block diagram for explaining a functional configuration example of a device 22 according to the second modification of an information processing system of the present embodiment.

FIG. 15 is an explanatory diagram for explaining an overview according to a third modification of the information processing system of the present embodiment.

FIG. 16 is a block diagram for explaining a functional configuration example of an action recognition device 33 according to a third modification of the information processing system of the present embodiment.

FIG. 17 is a block diagram illustrating an example of a hardware configuration 90.

### MODE FOR CARRYING OUT THE INVENTION

Hereinafter, a preferred embodiment of the present disclosure will be described in detail with reference to the accompanying drawings. Note that, in the present specification and drawings, components having substantially the same functional configuration are denoted by the same reference signs, and redundant description is omitted.

In addition, in the present specification and drawings, there is a case in which a plurality of components having substantially the same functional configuration is distinguished from each other with different alphabets or numbers attached after the same reference sign. However, in a case where it is not necessary to particularly distinguish each of the plurality of components having substantially the same functional configuration, only the same reference numeral is attached to each of the plurality of components.

Note that explanation will be made in the following order.
1. Outline of information processing system according to one embodiment of present invention
2. Functional configuration example
   2-1. Server
   2-2. Information processing device
3. Action example
4. Modifications
5. Hardware configuration example
6. Supplement

### 1. Overview of Information Processing System According to Embodiment of Present Disclosure

The present disclosure relates to a technology capable of performing indoor positioning with higher accuracy. As a preferable application of the present disclosure, for example, an example will be described in which the position of a user is measured in a scene where the user moves in an art exhibition or the like while carrying a device such as a smartphone in the venue, and audio commentary of an exhibition work is played back on the device near the work. According to the technology of the present disclosure, the position of the user can be measured with higher accuracy in an art exhibition or the like, and the content can be displayed in conjunction with the position information using the acquired position information of the user.

### (Review of Problems)

Conventionally, in indoor positioning, since radio waves from satellites are blocked, it has been difficult to perform positioning with high accuracy using reception signals from satellites such as GNSS. Therefore, for example, Patent Document 1 discloses a system that performs indoor positioning on the basis of indoor sensing data and uses the positioning result for action analysis.

As the sensing data used for indoor positioning, for example, an acceleration and angular velocity acquired by an inertial measurement unit (IMU) are used. When the acceleration and the angular velocity of the target device whose position information is desired to be acquired can be acquired, position measurement can be performed by calculating a relative position change of the device. However, in this method, an error (drift) between the estimated position information and the actual position may occur due to factors such as sensor noise.

Therefore, a method of reducing an error and improving accuracy of indoor positioning by installing environmental equipment in a place where indoor positioning is performed has also been studied. For example, a method has been studied in which a plurality of beacons is installed in a place where position measurement is performed in advance, and position measurement is performed using radio field intensity of Bluetooth Low Energy (BLE) or the like received by the device from the beacons. Alternatively, a method of measuring radio field strength (RSSI: Received Signal Strength Indicator) of a beacon transmitted from an indoor Wi-Fi (registered trademark) access point at each indoor point and creating fingerprint data (also referred to as finger mark data) of the RSSI in advance has also been studied.

However, in the method of adding environmental equipment and the method of acquiring environmental information such as fingerprint in advance as described above, there are economic and human costs related to installation of the equipment and a cost related to preliminary environmental information collection. For this reason, a technique that enables indoor positioning at a lower cost and with higher accuracy is desired.

Therefore, an embodiment of the present disclosure provides a technique capable of performing indoor positioning at lower cost and with high accuracy by enabling omission of installation of environmental equipment such as a beacon. More specifically, according to the embodiment of the present disclosure, it is possible to estimate position information of a device that is a target of position measurement with higher accuracy by using information of the user interaction performed using the device, in addition to sensing data acquired by the device.

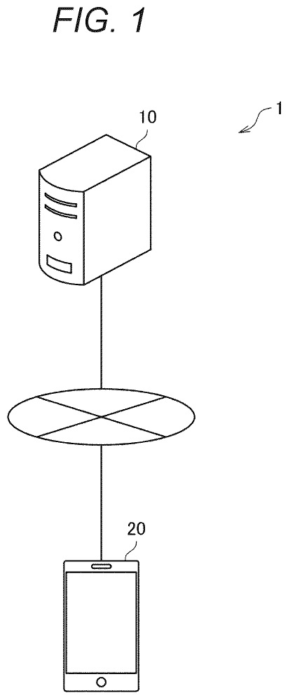

FIG. 1 is an explanatory diagram explaining an outline of an information processing system according to an embodiment of the present disclosure. As illustrated in FIG. 1, an information processing system 1 according to an embodiment of the present disclosure includes a server 10 and a device 20. The server 10 and the device 20 are configured to be able to communicate via a network.

The device 20 is an information processing device used by the user. The device 20 has a function of acquiring sensing data necessary for estimating position information of the device 20 itself. For example, the device 20 may have an IMU and obtain an acceleration and an angular velocity of the device 20. The device 20 estimates position information of the device 20 on the basis of the acquired sensing data.

Furthermore, the device 20 has a function of displaying information related to content such as audio for which the user can perform an operation such as playback, stopping, or fast-forwarding. For example, in the present embodiment, the content may be audio commentary of each of the exhibits of an art exhibition, which can be played, stopped, fast-forwarded, or the like by the user performing an operation. In the present embodiment, the device 20 generates and displays a content list screen including a list of operation buttons of the above audio commentary. At this time, the device 20 determines the content, the display order, and the like of the audio commentary to be displayed according to the position information of the device 20. As a result, on the device 20, for example, the operation buttons of audio commentary of the work can be displayed in order from the work closer to the position of the user U who is using the device 20.

Furthermore, the device 20 has a function of correcting the estimated position information of the device 20 on the basis of the content operation history performed by the user U on the device 20. The content operation history may be, for example, an operation history of the operation button of the above audio commentary detected in the device 20. In a case where the user U performs an operation of playing the audio commentary of any of the works, it is considered that the user U is highly likely to be located in the vicinity of the work. Therefore, the device 20 according to the present disclosure corrects the estimated position information of the device 20 on the basis of the position information such as coordinates associated with each work in advance and the content operation history by the user U.

The server 10 is a server including a storage unit that holds various types of information necessary for the device 20 to correct the position information. For example, the server 10 stores preset position information of each work exhibited in the art exhibition. The position information of each work may be, for example, coordinates in a two-dimensional space or a three-dimensional space. Furthermore, the position information of each work stored in the server 10 may be associated with reliability information indicating the size of a range in which the possibility that the user U who has actually played the audio commentary of a certain work is present exceeds the reference, with the coordinates indicated by each position information as the starting point. The device 20 can correct the estimated position information of the device 20 using the position information and the reliability information of each work described above. The reliability will be described in detail later.

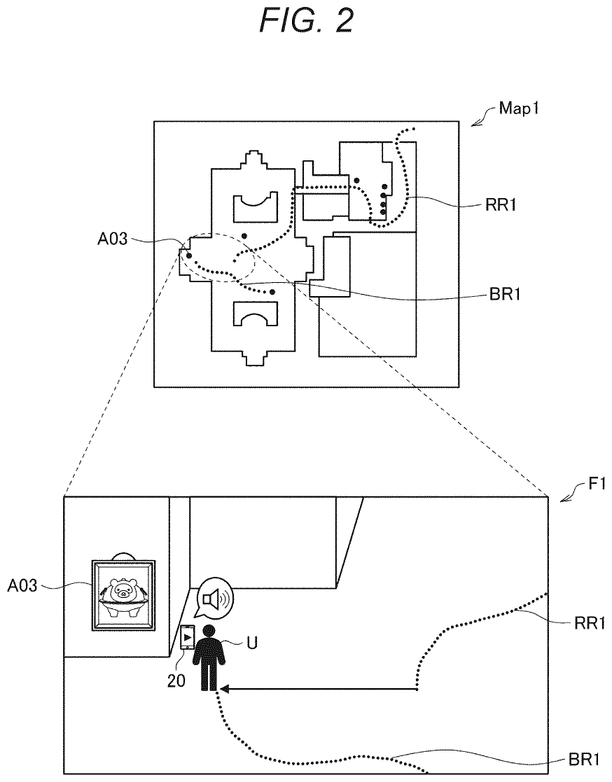

FIG. 2 is an explanatory diagram for explaining correction of position information performed by the device 20. Map1 illustrated in the upper part of FIG. 2 is an example of a map of a museum. The estimated position change RR1 illustrated in Map1 indicates the path of the position information of the device 20 estimated by the device 20. The post-correction position change BR1 indicates a path after the initially estimated position information of the device 20 is corrected by the device 20. A03 is an example of an exhibition work exhibited in the museum.

An enlarged view F1 illustrated in the lower part of FIG. 2 is a conceptual drawing in which the vicinity of the exhibition work A03 illustrated in the upper part is enlarged. As illustrated in the enlarged view F1, the user U moves in the museum while carrying the device 20. The device 20 estimates position information (path) of the device 20 on the basis of the acquired sensing data. As a result, it is assumed that the device 20 initially estimates the moving path indicated by the estimated position change RR1.

Next, it is assumed that the user U operates the device 20 in the vicinity of the exhibition work A03 and plays the audio commentary of the exhibition work A03. Then, the device 20 corrects the initially estimated position of the user U using the position information and the reliability information of the exhibition work A03 stored in advance in the server 10 on the basis of the playback of the audio commentary of the exhibition work A03. As a result, as illustrated in FIG. 2, the estimated position of the device 20 is corrected to the position indicated by the arrow. Thereafter, when the user U moves, a path indicated by the post-correction position change BR1 in which the post-correction estimated position becomes an end point is estimated.

In this manner, the device 20 estimates and corrects the position information by using the information related to the user interaction such as the content operation history in the device 20 in addition to the sensing data acquired by the device 20, whereby the accuracy of the indoor positioning of the device 20 can be further improved. In addition, according to such a technology of the present disclosure, since environmental equipment such as beacons or environmental information such as acquisition of Wi-Fi fingerprints is not collected, accuracy of indoor positioning can be improved while cost is reduced.

### 2. Functional Configuration Example

### <2-1. Server 10>

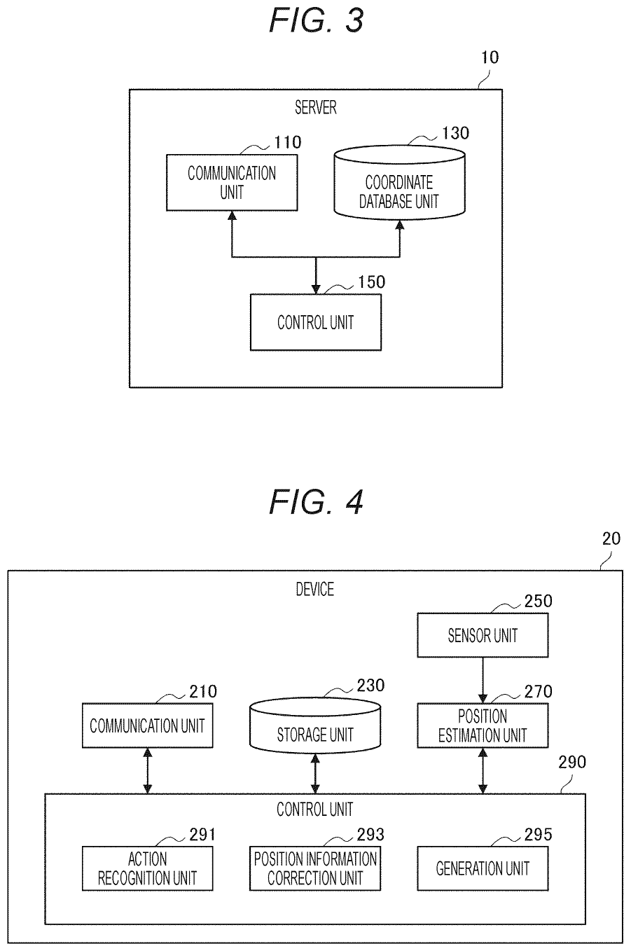

Next, a functional configuration example of the server 10 according to an embodiment of the present disclosure will be described with reference to FIG. 3. FIG. 3 is a block diagram for explaining an example of a functional configuration of the server 10 according to the present embodiment. As illustrated in FIG. 3, the server 10 includes a communication unit 110, a coordinate database unit 130, and a control unit 150.

### (Communication Unit 110)

The communication unit 110 has a function of communicating with other devices under the control of the control unit 150. For example, the communication unit 110 transmits coordinates and reliability information stored in the coordinate database unit 130 to the device 20.

### (Coordinate Database Unit 130)

The coordinate database unit 130 is a storage device capable of storing a program and data for operating the control unit 150. Furthermore, the coordinate database unit 130 can also temporarily store various data required in the process of the operation of the control unit 150. For example, the storage device may be a non-volatile storage device.

Such a coordinate database unit 130 stores content identification information that enables unique identification of the content to be displayed on the device 20 and the coordinates associated with this content identification information. As the coordinates, coordinates of a position where the user U appreciating the work is estimated to have the highest possibility of playing the audio commentary are set for each work exhibited in the art exhibition.

The above coordinates are set in advance in the coordinate database unit 130 on the basis of a site map of the art exhibition or a state of the site. Furthermore, the coordinates may be set by aggregating, for each work, coordinates of the positions where test users or the like have played the audio commentary corresponding to the work in the venue of the art exhibition. The coordinates associated with the content identification information in the coordinate database unit 130 are an example of the first coordinates.

Furthermore, the coordinate database unit 130 may store the above content identification information and the coordinates in association with reliability information. The reliability information is information indicating, for each work to be displayed, the size of a range in which the possibility that the user U who actually plays the audio commentary of the work is present exceeds the reference with the above coordinates as the starting point. The reliability information may be, for example, information of a length of a radius in meters, with the coordinates associated with each piece of content identification information as the starting point.

The above reliability information is set in advance in the coordinate database unit 130 together with the above coordinates on the basis of the site map of the art exhibition or the state of the site. At this time, for example, in a case where the size of the exhibition work is large and the user U can visually recognize the work even from a position away from the work, it is assumed that the range of the position where the user U is likely to play the audio commentary of the work is large. In this case, the reliability information of the work may be set relatively large. In a case where information indicating positions at which a plurality of users actually has played the audio commentary of the work is collected, an average value of the positions at which the audio commentary is played may be set as the coordinates, and a standard deviation of the positions at which the audio commentary is played may be set as the reliability information.

As described above, the reliability information associated with the content identification information and the coordinates in the coordinate database unit 130 is an example of the first reliability information.

### (Control Unit 150)

The control unit 150 controls the overall operation of the server 10. For example, the control unit 150 causes the communication unit 110 to transmit the content identification information, the coordinates associated with each piece of content identification information, and the reliability information stored in the coordinate database unit 130 to the device 20.

The functional configuration example of the server 10 has been described above with reference to FIG. 3. Next, a functional configuration example of the device 20 according to the present embodiment will be described with reference to FIG. 4.

### <2-2. Device 20>

FIG. 4 is a block diagram for explaining an example of a functional configuration of the device 20 according to the present embodiment. As illustrated in FIG. 4, the device 20 includes a communication unit 210, a storage unit 230, a sensor unit 250, a position estimation unit 270, and a control unit 290.

### (Communication Unit 210)

The communication unit 210 has a function of communicating with other devices under the control of the control unit 290. For example, the communication unit 210 receives, from the server 10, content identification information, and coordinates and reliability information associated with each piece of content identification information.

### (Storage Unit 230)

The storage unit 230 is a storage device capable of storing a program and data for operating the control unit 290. Furthermore, the storage unit 230 can also temporarily store various types of data required in the process of the operation of the control unit 290. For example, the storage device may be a non-volatile storage device.

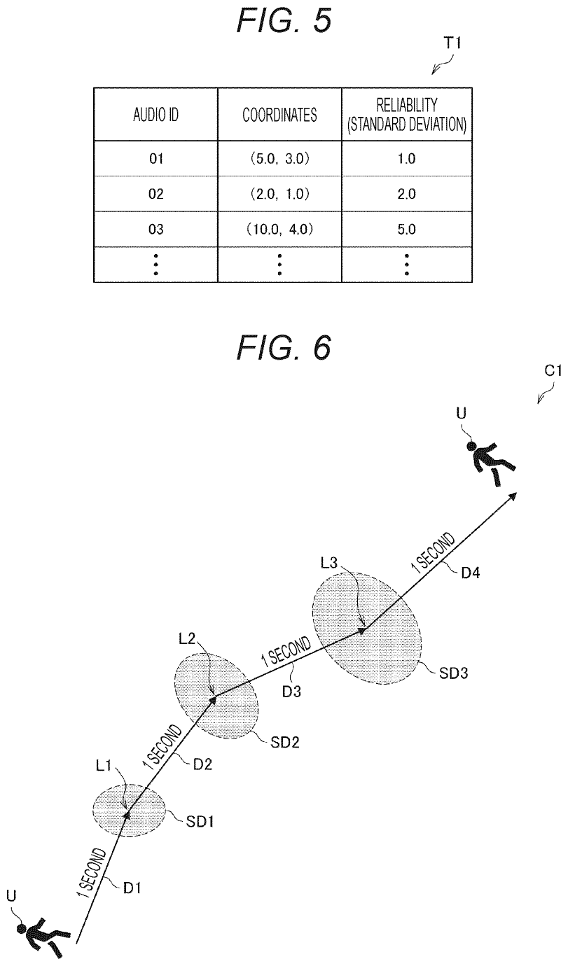

Under the control of the control unit 290, the storage unit 230 stores the content identification information received from the server 10, the coordinates and the reliability information associated with each piece of the content identification information. FIG. 5 is an explanatory diagram for explaining an example of content identification information, coordinates, and reliability information stored in the storage unit 230. As shown in FIG. 5, coordinate database table T1 includes audio ID, coordinates, and reliability (standard deviation).

The audio ID is an example of content identification information. In the example shown in the coordinate database table T1, the content identification information is a serial number audio ID starting from 01. However, the content identification information may be information in another format such as a symbol or an alphabet. The audio ID shown in the coordinate database table T1 is associated with the audio commentary of each work exhibited in the museum.

The coordinates are expressed by values on two axes with a point where two orthogonal axes intersect as the origin. In the example illustrated in FIG. 5, the unit of the value in each coordinate is meter. For example, the audio commentary having an audio ID of 01 is associated with coordinates indicating a position 5 m away from the origin on the X-axis and 3 m away from the origin on the Y-axis.

The reliability (standard deviation) is information indicating the size of a range in which the possibility that the user U who has played the audio commentary of the work is present exceeds the reference with the above coordinates as the starting point. In the example illustrated in FIG. 5, the unit of the value indicating the reliability is meter. For example, “1.0” is associated with the audio commentary having an audio ID of 01 as the reliability, which means that the range in which the possibility that the user U who has played the audio commentary is present exceeds the reference is a range with a radius of 1.0 m centered on the coordinates associated with the audio commentary.

A position information correction unit 293 described later corrects the estimated position information of the device 20 using the information of the coordinate database table T1 stored in the storage unit 230.

### (Sensor Unit 250)

The sensor unit 250 is a sensor capable of acquiring various sensing data related to the device 20. The sensor unit 250 is realized by, for example, an IMU including an acceleration sensor that detects acceleration of the device 20, and a gyroscope that detects an angle (orientation), an angular velocity, or an angular acceleration of the device 20. For example, the sensor unit 250 acquires acceleration and angular velocity of the device 20.

### (Position Estimation Unit 270)

The position estimation unit 270 has a function of estimating position information of the device 20 on the basis of the sensing data acquired by the sensor unit 250.

More specifically, the position estimation unit 270 may learn, by using machine learning, a relationship among the acceleration and the angular velocity of the device 20 obtained by a plurality of test users carrying the device 20 and moving in the museum in advance, correct answer data of walking speed of each test user, and correct answer data of the traveling direction of each test user. The position estimation unit 270 may estimate the position information of the device 20 using a model obtained as a result of learning. In this case, for example, the position estimation unit 270 may be realized by a deep neural network that outputs estimation values of changes in the walking speed and the traveling direction of the device 20 by using the above model with the acceleration and the angular velocity of the device 20 for 1 second as input data.

Furthermore, the position estimation unit 270 may estimate the position of the device 20 by integrating the estimation values of the change in the walking speed and the traveling direction of the device 20 output using the above model. The position of the device 20 may be, for example, coordinate information. The coordinates of the position of the device 20 estimated by the position estimation unit 270 are an example of second coordinates. At this time, the position estimation unit 270 may calculate the size of the range of error possibly included in the estimated position of the device 20 on the basis of a preset parameter in consideration of factors such as sensor noise of the sensor unit 250. The size of the above error range is an example of the second reliability.

### (Control Unit 290)

The control unit 290 has a function of controlling the overall operation of the device 20. For example, the control unit 290 controls communication between the communication unit 210 and the server 10. Such a control unit 290 has functions as an action recognition unit 291, a position information correction unit 293, and a generation unit 295.

The action recognition unit 291 has a function of recognizing an action of the user U who uses the device 20. For example, the action recognition unit 291 recognizes an action of the user U by acquiring the content operation history in the device 20. More specifically, for example, the action recognition unit 291 recognizes that the user U performs an operation such as playback, stopping, or fast-forwarding of any audio commentary on the list screen of the audio commentary displayed on the operation display unit (not illustrated in FIG. 4).

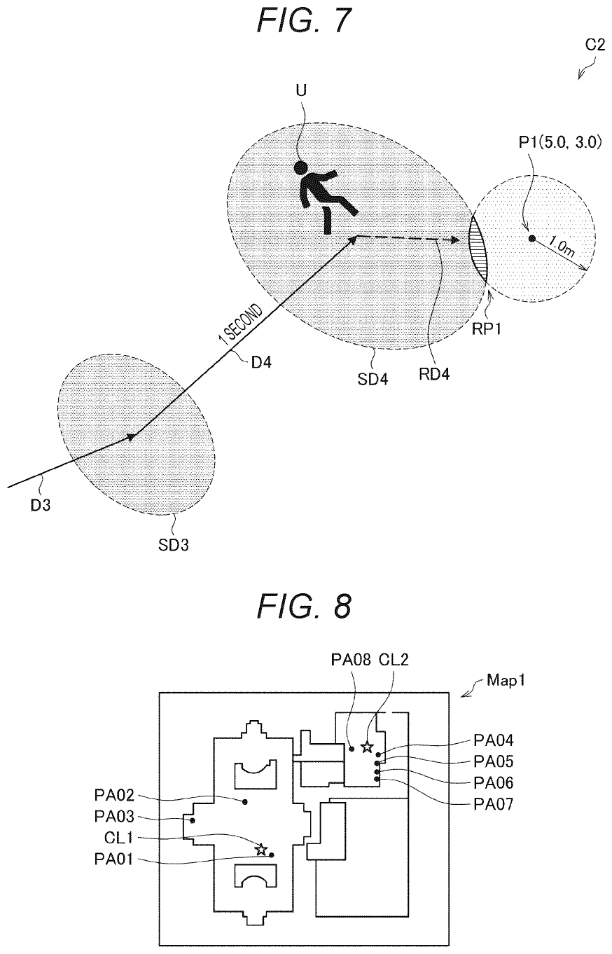

The position information correction unit 293 has a function of correcting the position information of the device 20 estimated by the position estimation unit 270 on the basis of the content operation history of the user recognized by the action recognition unit 291. Here, the correction of the position information by the position information correction unit 293 will be described in more detail with reference to FIGS. 6 and 7.

FIG. 6 is an explanatory diagram for explaining a position change of the device 20 before correction estimated by the position estimation unit 270. The user U carries the device 20, and the position of the device 20 is approximated to a degree that can be regarded as the same as the position of the user U. Therefore, in FIGS. 6 and 7, the estimated position of the device 20 will be described as the estimated position of the user U.

The estimated position change C1 illustrated in FIG. 6 indicates a position change of the user U every second. The traveling direction D indicates the traveling direction of the user U estimated by the position estimation unit 270. In addition, the point L indicates the estimated position of the user U for every second. The size of the ellipse of the range SD indicates a range of error that is calculated on the basis of a preset parameter and that may be included in the estimated position information.

As illustrated in FIG. 6, the position estimation unit 270 estimates the position information on the basis of parameters set in advance in consideration of factors such as sensor noise, assuming that the range SD starting from the estimated position of the user U for every second increases every time the position is estimated every second.

FIG. 7 is an explanatory diagram for explaining processing of correcting the estimated position information by the position information correction unit 293. Since the traveling direction D and the range SD included in the estimated position change C2 illustrated in FIG. 7 are as described with reference to FIG. 6, redundant description is omitted here. In FIG. 7, it is assumed that the audio commentary related to the audio ID01 associated with the coordinates P1 is played by the user U after the estimated position change C1 before correction illustrated in FIG. 6 is estimated.

First, the action recognition unit 291 recognizes that an operation of playing the audio commentary having the audio ID 01 has been performed on the device 20. The position information correction unit 293 refers to the coordinate database table T1 stored in the storage unit 230, and specifies the coordinates and reliability associated with the audio ID 01. In the example of the coordinate database table T1 illustrated in FIG. 5, it is understood that the coordinates associated with the audio ID 01 are (5.0, 3.0). It is also understood that the reliability associated with the coordinates is 1.0.

As illustrated in FIG. 7, the position information correction unit 293 recalculates and corrects the position information of the user U on the basis of the coordinate information of the specified coordinates P1 and the fact that the error range indicated by the reliability of the coordinates is a radius of 1.0 meters. In the example illustrated in FIG. 7, the estimated position of the user U is corrected to the vicinity of the corrected estimated position RP1 on the basis of the terminal point in the traveling direction D4, which is the coordinates of the initial estimated position, and the range SD4, and the coordinates P1 and information of a radius of 1.0 meters, which is a range in which the possibility that the user U is located exceeds the reference and associated with the coordinates P1. Furthermore, the range in which the possibility that the user U is located exceeds the reference, calculated as the reliability information of the initial estimated position, is also corrected by the position information correction unit 293 on the basis of the value of the radius of 1.0 meter, which is the reliability information associated with the coordinates P1.

Such a position information correction unit 293 may be realized by using a neural network that takes, as inputs, the estimated position of the user U estimated by the position estimation unit 270, the error range (reliability information) related to the estimated position, the walking speed of the user U, the change in the traveling direction, the coordinates of the coordinate database table T1 stored in the storage unit 230, and the reliability information related to the coordinates. The position information correction unit 293 may learn the relationship between the estimated position of the user U, the error range of the position, the walking speed, the change in the traveling direction, the above coordinates, and the reliability information related to the coordinates using the above neural network. At this time, the position information correction unit 293 may further perform learning using a calculation method such as an unscented Kalman filter (UKF), a Kalman filter, or a particle filter, for example.

The position information correction unit 293 may correct the position information of the device 20 using the model obtained as a result of the above learning. In this case, the position information correction unit 293 outputs the corrected current position and traveling direction of the user U. The processing of correcting the position information by the position information correction unit 293 has been described above with reference to FIGS. 6 and 7. Returning to FIG. 4, the description of the functional configuration example of the device 20 will be continued.

The generation unit 295 has a function of generating a list screen of content displayed on the device 20. For example, the generation unit 295 generates a list screen of audio commentary of the works in the art exhibition. Furthermore, the generation unit 295 determines the display position or the display order of the content on the basis of the position information of the device 20 estimated and corrected by the position estimation unit 270 and the position information correction unit 293. Here, an example of a content list screen generated by the generation unit 295 will be described with reference to FIGS. 8 to 11.

FIG. 8 is a conceptual drawing of a map of a museum illustrating a work position corresponding to each piece of content for explaining the content list screen generated by the generation unit 295. As illustrated in FIG. 8, Map1 includes positions PA (PA01 to PA08). CL1 is the position of the user U at a certain time point, and CL2 is the position of the user U at another time point.

The positions PA indicate the positions of the works installed in the museum. In the example illustrated in FIG. 8, PA01 to PA08 correspond to the positions of the exhibition works A01 to A08 having audio IDs of 01 to 08, respectively. Content identification information (audio ID), coordinates, and reliability information corresponding to each of the positions PA are stored in the coordinate database unit 130 of the server 10 and the storage unit 230 of the device 20.

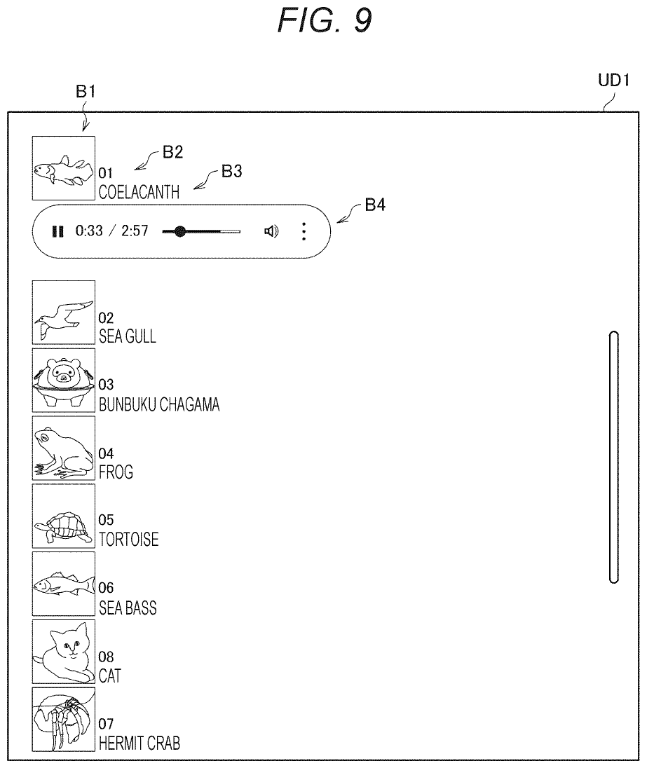

First, it is assumed that the user U is at the position CL1 illustrated in FIG. 8. That is, it is assumed that the position of the device 20 is estimated to be the position CL1. FIG. 9 is an explanatory diagram illustrating an example of a content list screen generated by the generation unit 295 in a case where the position of the device 20 is estimated to be the position CL1.

As illustrated in FIG. 9, the content list screen UD1 may include, for each of the works of the exhibition work A01 to exhibition work A07, an icon indicating the work, a work name, and a button with which audio commentary can be operated, for example. The user U can display the operation button of the audio commentary of each work by performing an operation of touching the icon of the work on the content list screen UD1 displayed on the operation display unit of the device 20. Furthermore, the user U can perform an operation such as playback, stopping, or fast-forwarding the audio commentary of an arbitrary work from among the works displayed in the list by touching the operation button of the audio commentary.

In the example illustrated in FIG. 9, it is understood that the icon B1 of coelacanth, which is the work corresponding to the exhibition work A01, the audio ID B2, the work name B3, and the audio commentary operation button B4 are displayed at the uppermost stage of the content list screen UD1. On the basis of the position information of the device 20 estimated and corrected by the position estimation unit 270 and the position information correction unit 293, the generation unit 295 determines the display order of the operation button of the audio commentary corresponding to the exhibition work A01, which is the work closest to the position CL1 of the device 20, as the highest order.

In addition, in the example illustrated in FIG. 9, as for the exhibition works from the exhibition work A02, it is understood that icons and the like of the respective works are displayed in the order of increasing distance, following the exhibition work A01, from the position CL1 in Map1 of FIG. 8.

In this manner, the generation unit 295 determines the display order of the operation buttons of the audio commentary of the works on the basis of the position information estimated by the device 20, so that the work closest to the current position of the user U moving through the venue of the art exhibition is displayed higher on the content list screen UD. Therefore, the convenience of the user U is improved.

As described above, on the basis of the estimated position information of the device 20, the generation unit 295 determines the display order such that the operation button of the audio commentary of the work closer to the position indicated by the position information is displayed higher on the content list screen UD. At this time, the generation unit 295 may determine the display order of the operation buttons of the audio commentary of the works in the ascending order of the length of the linear distance between the estimated position of the device 20 and each work. Alternatively, for example, in a case where the browsing route of the works is determined in advance in the art exhibition, the generation unit 295 may determine the display order of the operation buttons of the audio commentary of the works on the basis of the order of the works according to the browsing route.

Furthermore, the generation unit 295 may determine the display position or the display order on the basis of the estimated traveling direction of the device 20 such that the operation button of the audio commentary associated with the coordinates of the work located on the estimated traveling direction side of the device 20 is displayed higher than the operation button of the audio commentary associated with the coordinates of the work located on the opposite side of the estimated traveling direction of the device 20. As a result, for example, the operation button of the audio commentary of a work in the direction in which the user U is moving can be displayed higher than the operation button of the audio commentary of a work in the direction different from the above direction.

Furthermore, it is assumed that the user U moves and the position of the device 20 changes from the position CL1 to the position CL2 illustrated in FIG. 8. At this time, if there is a deviation (so-called drift) between the position information of the device 20 estimated by the position estimation unit 270 and the position CL2, a deviation may occur between the display order of the audio commentary displayed on the content list screen UD and the order of the works close to the position CL2.

Here, it is assumed that a playback operation of the audio commentary of the exhibition work A04 has been detected in the device 20. Then, the position information correction unit 293 corrects the position information of the device 20 on the basis of the coordinates and the reliability associated with the exhibition work A04. When the position information of the device 20 is corrected by the position information correction unit 293, the generation unit 295 updates the display order of the audio commentary on the basis of the corrected position information of the device 20.

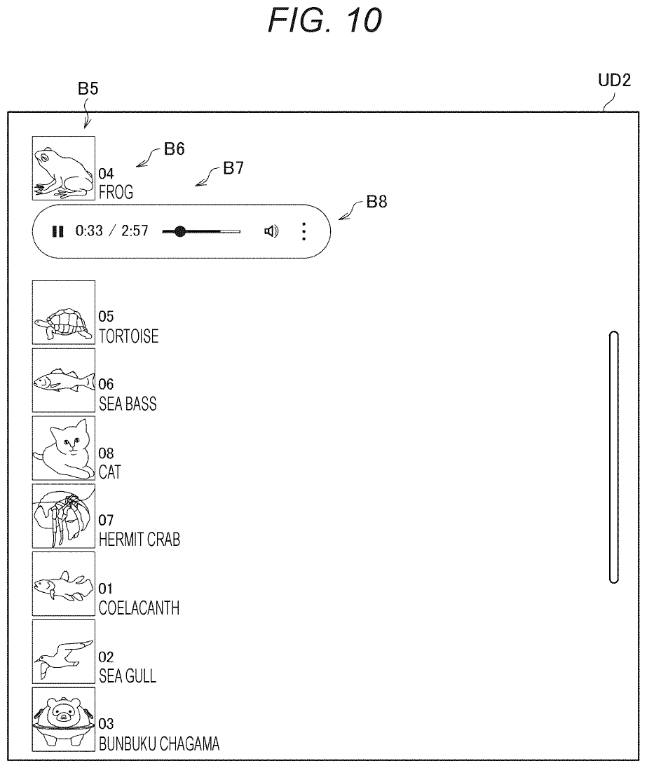

FIG. 10 is an explanatory diagram illustrating an example of a content list screen generated by the generation unit 295 in a case where the position of the device 20 after being corrected by the position information correction unit 293 is the position CL2. As illustrated in FIG. 10, it is understood that the icon B5, the audio IDB6, the work name B7, and the audio commentary operation button B8 of a frog, which is the work corresponding to the exhibition work A04, are displayed at the uppermost stage of the content list screen UD2. In addition, it is understood that the exhibition work A05 is displayed next to the exhibition work A04, and the audio commentary of each work is displayed in the order of increasing distance from the position CL2 on Map1 illustrated in FIG. 8.

As described above, even in a case where there is a deviation between the position information of the device 20 estimated by the position estimation unit 270 on the basis of the sensing data and the actual current position of the device 20, the position information correction unit 293 corrects the position information of the device 20 when an operation on the audio commentary of any work is detected in the device 20. Further, when the position information of the device 20 is corrected, the generation unit 295 updates the display position or the display order of the audio commentary on the basis of the corrected position information of the device 20. As a result, each time the content operation history is detected in the device 20, the estimated position information of the device 20 is corrected, and the accuracy of the estimated position is further improved. Furthermore, since the corrected position information of the device 20 is fed back to the display position or the display order of the content displayed on the device 20, it is possible to present more accurate content based on the position information of the device 20 to the user U who uses the device 20.

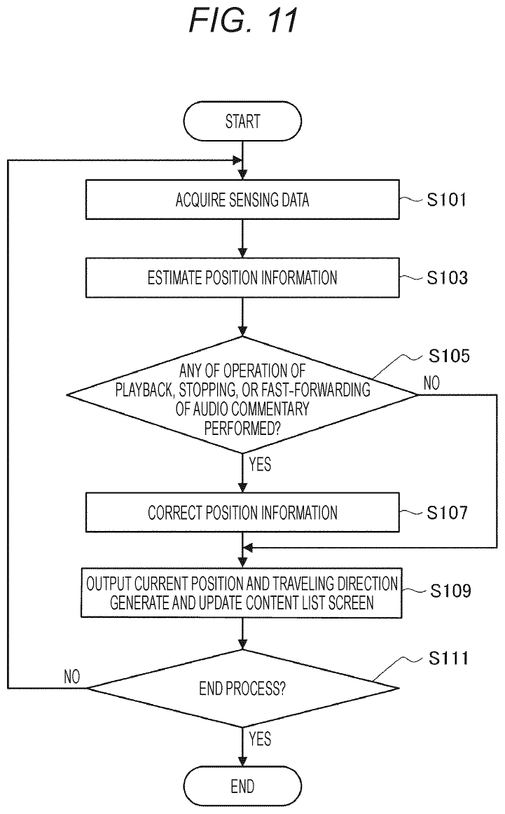

The functional configuration example of the device 20 according to the present embodiment has been described above with reference to FIG. 4. Next, an operation example of the device 20 according to the present embodiment will be described with reference to FIG. 11.

### 3. Operation Example

FIG. 11 is a flowchart for explaining an operation example of the device 20 according to the present embodiment. First, the sensor unit 250 of the device 20 acquires sensing data (S101). For example, the sensor unit 250 acquires acceleration and angular velocity of the device 20.

Next, the position estimation unit 270 estimates position information of the device 20 on the basis of the acquired sensing data (S103).

When the action recognition unit 291 does not recognize that any of an operation of playback, stopping, or fast-forwarding of the content is performed on the device 20 (S105/NO), the process proceeds to S109.

When the action recognition unit 291 recognizes that any operation such as playback, stopping, or fast-forwarding of the content has been performed (S105/YES), the position information correction unit 293 corrects the position information of the device 20 estimated in S103 with reference to the coordinate database table T1 stored in the storage unit 230 (S107).

The position estimation unit 270 outputs the estimated position information (current position and traveling direction) of the device 20. Alternatively, in a case where the above position information is corrected by the position information correction unit 293 in S107, the position information correction unit 293 outputs the corrected position information (current position and traveling direction) of the device 20. The generation unit 295 generates and updates the content list screen on the basis of the output position information of the device 20 (S109).

In the device 20, in a case where a predetermined end operation for instructing the end of the series of processing of the device 20 is performed (S111/YES), the device 20 ends the series of processing. The predetermined operation may be, for example, pressing of a button for ending the display of the content list screen by an operation of the user U on the operation display unit of the device 20. Alternatively, the predetermined termination operation may be that the WEB application for displaying the content list screen is terminated by the user U in the device 20.

In a case where the predetermined termination operation is not performed on the device 20 (S111/NO), the device 20 repeats the processing of S101 to S109.

The operation example of the device 20 according to the present embodiment has been described above with reference to FIG. 11.

### 4. Modifications

Note that, in the above embodiment, the content identification information, the coordinates, and the reliability information are stored in association with each other in the coordinate database unit 130 of the server 10. Further, the device 20 receives the above content identification information, the coordinates, and the reliability information from the server 10, stores them in the storage unit 230 of the device 20, and uses the stored various types of information for the processing of correcting the position information of the device 20. However, the information processing system 1 according to the present disclosure can also adopt the following configuration.

### First Modification

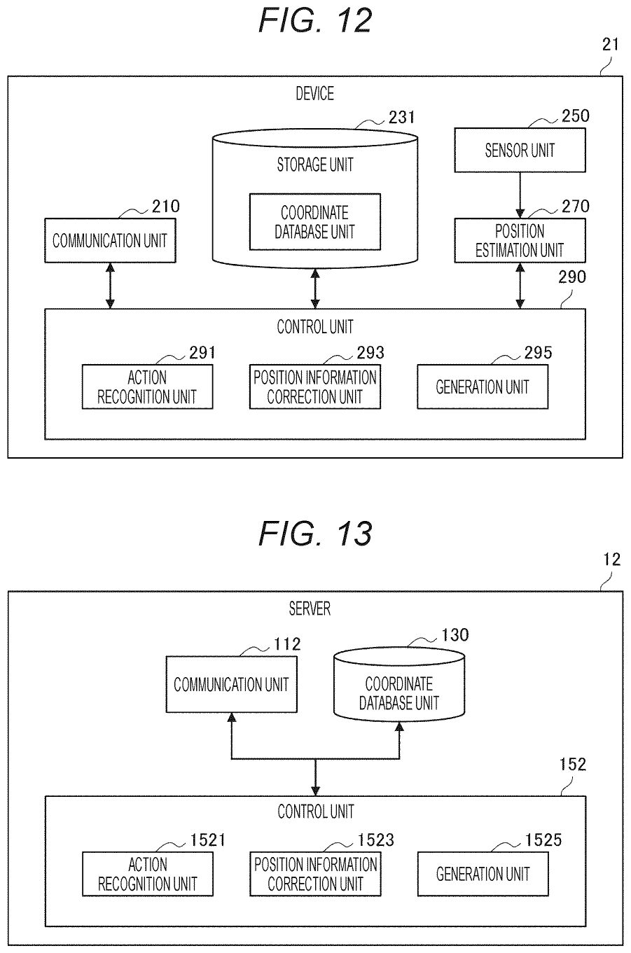

For example, the device 20 may have the function of the coordinate database unit 130 included in the server 10, and the information processing system according to the present disclosure may be realized only by the device 20. FIG. 12 is a block diagram for explaining a functional configuration example of a device 21 according to a first modification of an information processing system of the present embodiment.

As illustrated in FIG. 12, the device 21 is different from the functional configuration of the device 20 described with reference to FIG. 4 in the configuration of the storage unit 231. The storage unit 231 of the device 21 stores a coordinate database unit in advance. According to such a configuration of the device 21, the information processing system according to the embodiment of the present disclosure can also be realized by a configuration including only the device 20 without including the server 10.

### Second Modification

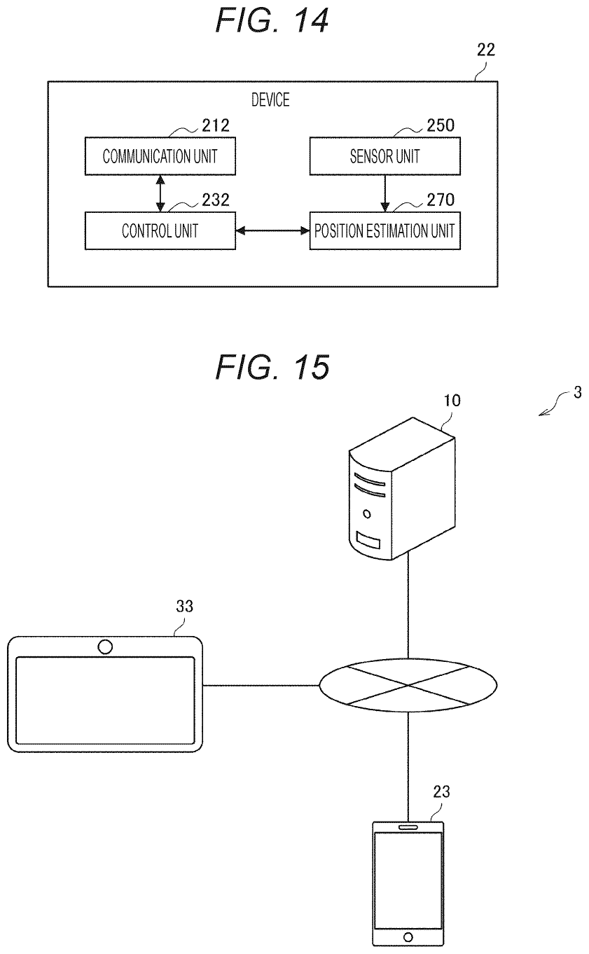

Alternatively, the server 10 may have the functions of the action recognition unit 291, the position information correction unit 293, and the generation unit 295 of the device 20 described with reference to FIG. 4. In this case, processing of correcting the position information of the device 20 may be performed on the side of the server 10. Here, a functional configuration example of each of the server and the device according to the second modification as described above will be described with reference to FIGS. 13 and 14.

FIG. 13 is a block diagram for describing a functional configuration example of the server 12 according to the second modification of the information processing system of the present embodiment. As illustrated in FIG. 13, the server 12 has functions of a communication unit 112, a coordinate database unit 130, and a control unit 152. Note that, in FIG. 13, the coordinate database unit 130 is as described above with reference to FIG. 3, and thus overlapping description is omitted here.

The communication unit 112 has a function of communicating with the device 20 under the control of the control unit 152. The communication unit 112 acquires position information of the device 22 from the device 22 to be described later. Furthermore, the communication unit 112 acquires the content operation history from the device 22.

The control unit 152 has a function of controlling the overall operation of the server 12. Such a control unit 152 has functions as an action recognition unit 1521, a position information correction unit 1523, and a generation unit 1525.

The action recognition unit 1521 has a configuration corresponding to the action recognition unit 291 described with reference to FIG. 4. The action recognition unit 1521 recognizes an action of the user U who uses the device 22 on the basis of the content operation history received from the device 22.

The position information correction unit 1523 has a configuration corresponding to the position information correction unit 293. When the action recognition unit 1521 recognizes the user's operation on the content such as playback, stopping, or fast-forwarding of the audio commentary in the device 22, the position information correction unit 1523 corrects the position information of the device 22 acquired from the device 22.

The generation unit 1525 has a configuration corresponding to the generation unit 295. The generation unit 1525 generates the content list screen on the basis of the position information of the device 22 received from the device 22. In addition, when the position information of the device 22 is corrected by the position information correction unit 1523, the generation unit 1525 updates the display of the content list screen. The content list screen generated and updated by the generation unit 1525 is transmitted from the communication unit 112 to the device 22 and displayed on the device 22.

FIG. 14 is a block diagram for describing a functional configuration example of a device 22 according to a second modification of the information processing system of the present embodiment. As illustrated in FIG. 14, the device 22 includes a communication unit 212, a control unit 232, a sensor unit 250, and a position estimation unit 270. Note that the sensor unit 250 and the position estimation unit 270 are as described above with reference to FIG. 4, and thus overlapping description is omitted here.

The communication unit 212 has a function of communicating with the server 12 under the control of the control unit 232. The device 22 transmits the estimated position information of the device 22 output by the position estimation unit 270 to the server 12. In addition, under the control of the control unit 232, the communication unit 212 transmits a content operation history detected on an operation display unit (not illustrated in FIG. 14) to the server 12.

The control unit 232 controls the overall operation of the device 22. For example, the control unit 232 causes the communication unit 212 to transmit the position information of the device 22 preferred by the position estimation unit 270 to the server 12. Furthermore, the control unit 232 performs control to display the content list screen received by the communication unit 212 on an operation display unit (not illustrated in FIG. 4).

The functional configuration examples of the server 12 and the device 20 according to the second modification of the information processing system of the present embodiment have been described above with reference to FIGS. 13 and 14.

### Third Modification

Furthermore, the function as the action recognition unit 291 included in the device 20 in the above-described embodiment may be realized by a device different from the device 20. FIG. 15 is an explanatory diagram for describing an overview according to a third modification of the information processing system of the present embodiment.

In the example illustrated in FIG. 15, the information processing system 3 includes a server 10, a device 23, and an action recognition device 33. The server 10, the device 23, and the action recognition device 33 are configured to be communicable via a network. Note that the server 10 is as described above with reference to FIG. 1, and thus overlapping description is omitted here.

The device 23 has the functions of the device 20 described with reference to FIG. 4, excluding the action recognition unit 291. In the information processing system 3, the device 23 may acquire a content operation history detected by the action recognition device 33 from the action recognition device 33, and correct the position information of the device 23 on the basis of the content operation history.

The action recognition device 33 is a device having a function as the action recognition unit 291 of the device 20 described above with reference to FIG. 4. The action recognition device 33 recognizes a user's action and transmits a recognition result to the device 23 as a content operation history. At this time, the user's action recognized by the action recognition device 33 is associated with position information of a position where the user is likely to perform the action. As a result, the device 23 can correct the position information of the device 23 estimated by the device 23 on the basis of the user's action recognized by the action recognition device 33. The action of the user and the coordinates of the position where the action is likely to be performed may be stored in advance in the coordinate database unit 130 of the server 10.

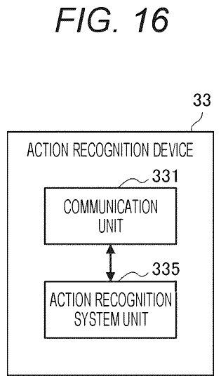

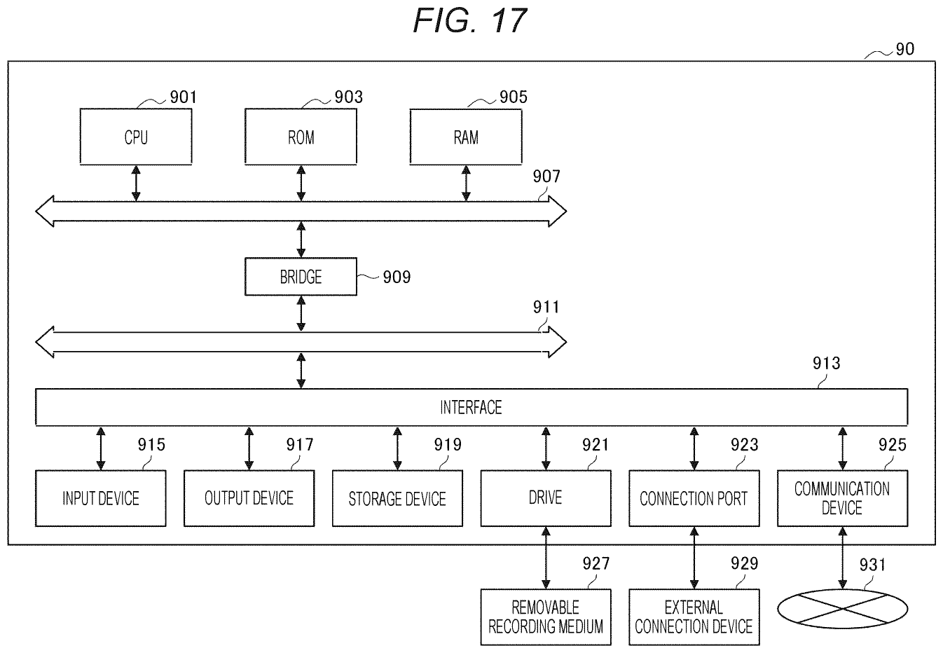

FIG. 16 is a block diagram for describing a functional configuration example of an action recognition device 33 according to a third modification of the information processing system of the present embodiment. As illustrated in FIG. 17, the action recognition device 33 includes a communication unit 331 and an action recognition system unit 335.

The communication unit 331 has a function of communicating with the device 23. For example, the communication unit 331 transmits a content operation history indicating the user's action recognized by the action recognition system unit 335 to the device 23.

The action recognition system unit 335 has a function of recognizing a user's action. The action recognition system unit 335 includes various sensors for acquiring necessary information according to the type of action to be recognized. For example, the action recognition system unit 335 may include an IMU. In this case, the action recognition system unit 335 may recognize the user's action by detecting the position and orientation of the action recognition device 33 on the basis of the acceleration and the acceleration of the action recognition device 33.

Such an action recognition device 33 may be realized by, for example, a tablet terminal or a smartphone. In this case, the action recognition system unit 335 of the action recognition device 33 may include an operation display unit, and may detect various operations such as a screen tap detected in the operation display unit and transmit the detected operations to the device 23 as a content operation history.

Alternatively, the action recognition device 33 may be an information processing terminal built in a device such as an item that is used in user experience-based contents or the like and gripped by the user. In this case, for example, the action recognition device 33 may include an IMU, and may detect the position and orientation of the action recognition device 33 itself. Furthermore, the action recognition device 33 may recognize that the user takes a specific posture at a predetermined position in a state of gripping the above item on the basis of sensing data by the IMU. Furthermore, the action recognition device 33 may transmit that the user takes a specific posture to the action recognition device 33 as the content operation history.

The third modification of the information processing system of the present embodiment has been described above with reference to FIGS. 15 and 16.

### 5. Hardware Configuration Example

The embodiments of the present disclosure have been described above. Information processing such as estimation of the position information based on the sensing data, correction of the estimated position information, and generation and update of the content list screen based on the estimated position information is realized by cooperation of software and hardware. Hereinafter, a hardware configuration example that can be applied to the server 10 and the device 20 will be described.

FIG. 17 is a block diagram illustrating an example of a hardware configuration 90. Note that the hardware configuration example of the hardware configuration 90 described below is merely an example of the hardware configurations of the server 10 and the device 20. Therefore, each of the server 10 and the device 20 does not necessarily have the entire hardware configuration illustrated in FIG. 17. In addition, a part of the hardware configuration illustrated in FIG. 17 may not exist in the server 10 and the device 20. Furthermore, the hardware configuration 90 described below can also be applied to the server 12, the device 21, the device 22, the device 23, and the action recognition device 33.

As illustrated in FIG. 17, the hardware configuration 90 includes a CPU 901, a read only memory (ROM) 903, and a RAM 905. In addition, the hardware configuration 90 may include a host bus 907, a bridge 909, an external bus 911, an interface 913, an input device 915, an output device 917, a storage device 919, a drive 921, a connection port 923, and a communication device 925. The hardware configuration 90 may include a processing circuit called a graphics processing unit (GPU), a digital signal processor (DSP), or an application specific integrated circuit (ASIC) instead of or in addition to the CPU 901.

The CPU 901 functions as an arithmetic processing device and a control device, and controls the overall operation in the hardware configuration 90 or a part thereof according to various programs recorded in the ROM 903, the RAM 905, the storage device 919, or a removable recording medium 927. The ROM 903 stores programs, operation parameters, and the like used by the CPU 901. The RAM 905 temporarily stores programs used in the execution of the CPU 901 and/or parameters that appropriately change in the execution, for example. The CPU 901, the ROM 903, and the RAM 905 are mutually connected by the host bus 907 including an internal bus such as a CPU bus. Moreover, the host bus 907 is connected to the external bus 911 such as a peripheral component interconnect/interface (PCI) bus via the bridge 909.

When the CPU 901 cooperates with the ROM 903, the RAM 905, and software, for example, the functions of the control unit 150, the control unit 290, the control unit 152, the control unit 232, and the action recognition system unit 335 can be realized.

The input device 915 is, for example, a device operated by the user, such as a button. The input device 915 may include a mouse, a keyboard, a touch panel, a switch, a lever, or the like. Furthermore, the input device 915 may also include a microphone that detects voice of the user. The input device 915 may be, for example, a remote control device using infrared rays or other radio waves, or an external connection device 929 such as a mobile phone corresponding to the operation of the hardware configuration 90. The input device 915 includes an input control circuit that generates and outputs an input signal to the CPU 901 on the basis of the information input by the user. By operating the input device 915, the user inputs various data to the hardware configuration 90 and instructs processing operation.

Furthermore, the input device 915 may include an imaging device and a sensor. The imaging device is, for example, a device that generates a captured image by imaging a real space using various members such as an imaging element such as a charge coupled device (CCD) or a complementary metal oxide semiconductor (CMOS), and a lens for controlling image formation of a subject image on the imaging element. The imaging device may capture a still image or may capture a moving image.

The sensor is, for example, a sensor of various types, such as a distance measuring sensor, an acceleration sensor, a gyro sensor, a geomagnetic sensor, a vibration sensor, a light sensor, or a sound sensor. The sensor acquires information regarding the state of the hardware configuration 90 itself, such as the orientation of the housing of the hardware configuration 90, or information regarding the surrounding environment of the hardware configuration 90, such as brightness or noise around the hardware configuration 90. Furthermore, the sensor may also include a global positioning system (GPS) sensor that receives a GPS signal to measure the latitude, longitude, and altitude of the device.

The output device 917 includes a device that can visually or audibly notify the user of acquired information. The output device 917 may be, for example, a display device such as a liquid crystal display (LCD) or an organic electro-luminescence (EL) display, a sound output device such as a speaker or a headphone, or the like. Furthermore, the output device 917 may include a plasma display panel (PDP), a projector, a hologram, a printer device, or the like. The output device 917 outputs a result obtained by the processing of the hardware configuration 90 as a video such as a text or an image, or as a sound such as voice or audio. Furthermore, the output device 917 may include a lighting device or the like that brightens the surroundings.

The storage device 919 is a data storage device configured as an example of a storage unit of the hardware configuration 90. The storage device 919 includes, for example, a magnetic storage device such as a hard disk drive (HDD), a semiconductor storage device, an optical storage device, a magneto-optical storage device, or the like. The storage device 919 stores programs or various data executed by the CPU 901, various data acquired from the outside, and the like.

The drive 921 is a reader/writer for a removable recording medium 927, such as a magnetic disk, an optical disk, a magneto-optical disk, or a semiconductor memory, and is built in or externally attached to the hardware configuration 90. The drive 921 reads information recorded in the mounted removable recording medium 927, and outputs the read information to the RAM 905. Furthermore, the drive 921 writes records in the mounted removable recording medium 927.

The connection port 923 is a port for directly connecting a device to the hardware configuration 90. The connection port 923 may be, for example, a universal serial bus (USB) port, an IEEE1394 port, a small computer system interface (SCSI) port, or the like. Furthermore, the connection port 923 may be an RS-232C port, an optical audio terminal, a high-definition multimedia interface (HDMI (registered trademark)) port, or the like. By connecting the external connection device 929 to the connection port 923, various types of data can be exchanged between the hardware configuration 90 and the external connection device 929.

The communication device 925 is, for example, a communication interface including a communication device or the like for connecting to a local network or a communication network with a base station of wireless communication. The communication device 925 may be, for example, a communication card for wired or wireless local area network (LAN), Bluetooth (registered trademark), Wi-Fi (registered trademark), or wireless USB (WUSB). Furthermore, the communication device 925 may be a router for optical communication, a router for asymmetric digital subscriber line (ADSL), a modem for various types of communication, or the like. For example, the communication device 925 transmits and receives signals and the like to and from the Internet or other communication equipment, by using a predetermined protocol such as TCP/IP. Furthermore, a communication network with a local network or a base station connected to the communication device 925 is a network connected in a wired or wireless manner, and is, for example, the Internet, a home LAN, infrared communication, radio wave communication, satellite communication, or the like.

### 6. Supplement

The preferred embodiments of the present disclosure have been described above in detail with reference to the accompanying drawings, but the technical scope of the present disclosure is not limited to such examples. It is obvious that those with ordinary skill in the technical field of the present disclosure can conceive various alterations or corrections within the scope of the technical idea recited in the claims, and it is naturally understood that these alterations or corrections also fall within the technical scope of the present disclosure.

For example, in the above-described embodiment, as a preferable application of the present disclosure, an example has been described in which indoor positioning in an art exhibition is performed, display of a list screen of audio commentary of works being exhibited is generated and updated on the basis of estimated position information, and the position information is further corrected on the basis of an operation of a user on the list screen. The present technology, however, is not limited to such an example. For example, the content operation history acquired by the device 20 may be a history of an operation with respect to the audio commentary of the work, or a history of another operation that can be associated with each work, such as an operation of pressing a button for displaying a caption of the work displayed on the device 20.

Furthermore, in the above embodiment, the position information correction unit 293 corrects the position information of the device 20 on the basis of the content operation history detected in the device 20. However, the present disclosure is not limited to such an example. For example, the information processing system according to the present disclosure may further include a camera (not illustrated in FIG. 1). The camera may be installed in advance at a position where the user U carrying the device 20 can be imaged. In this case, the device 20 may detect the user U by performing image recognition from the image obtained by the camera. Additionally, the position information correction unit 293 may correct the position information of the device 20 using coordinates derived from the installation position or the angle of view of the above camera on the basis of the detection of the user U from the above image.

Furthermore, in the above-described embodiment, an example has been described in which the position information corrected by the position information correction unit 293 is used to determine and update the display order of the content list screen displayed on the device 20. However, the device 20 may simply transmit the above position information to another apparatus. As a result, it is possible to perform application such as analyzing a flow line or an action of the user on the other apparatus side using the above position information acquired by the device 20.

Furthermore, in the above embodiment, an example of indoor positioning in an art exhibition has been mainly described as a preferable application of the present disclosure, but the preferable application of the present disclosure is not limited to such an example. For example, as another example of a preferred application of the present disclosure, the present technology can be applied to location based entertainment (LBE). More specifically, for example, there is experience-based content in which the user participates while gripping an item such as a sword in which a sensor such as an IMU is embedded. In this case, the position information of the item may be estimated using the acceleration and the angular velocity acquired by the IMU. Furthermore, as the content operation history of the user, it may be detected that the user has taken a predetermined action such as a specific posture (for example, a posture of holding a sword) while gripping the item. The device 20 can improve the accuracy of the position information of the user by using the coordinates of the position where the specific posture should be performed on the basis of the fact that the user takes the specific posture.

In addition, as an example of another suitable application, there is search-type experience-based content in which the user searches for problem sentences installed at a plurality of places in a specific town or area, inputs an answer, and proceeds to the next problem. In this case, the device 20 may acquire, as the content operation history, that an operation such as input of character information of an answer to the question sentence has been performed on the operation display unit of the device 20. Furthermore, the device 20 can correct the position information of the device 20 by using the coordinates of the position where the question sentence corresponding to the answer for which the input operation has been performed is installed.

Furthermore, as an example of another suitable application, a predetermined action of the user may be recognized on the basis of sensing data obtained from the device 20 carried by the user or another portable device such as a smartphone, and the position information of the user may be corrected using the coordinates of a place where the action is to be performed. More specifically, for example, an action such as the user getting on an escalator or getting on or off a train may be recognized on the basis of the acceleration obtained from the smartphone carried by the user. Alternatively, holding the smartphone carried by the user over an IC reader at a ticket gate of a station to pay the fare may be recognized as an action of the user. The device 20 can correct the position information of the user using the results of the action recognition. Consequently, the accuracy of the position information can be improved even in the position measurement in a building, such as a department store, or the indoor position measurement in a station.

In addition, as an example of another suitable application, there is an example in which position information of a product cart with a device configured to include a product scanner, which is used in a retail store such as a supermarket, is measured. For example, there is provided a service in which a customer causes a scanner of a device attached to a product cart to read a barcode of a product, and the customer himself/herself settles the price of the product on the above device. In this case, since product scanning is often performed in the vicinity of the product shelf on which the product is placed, it is possible to correct the position information of the above product cart using the coordinates in the vicinity of the above product shelf on the basis of reading of a certain product by the scanner. As a result, for example, it is possible to improve the accuracy of the position of the product cart itself displayed on the device, guide display in the store, or the like. Alternatively, an application is possible in which information on travel routes of a plurality of customers in the store is collected and used for flow line analysis of the customers.

Furthermore, the steps in the processing of the operations of the server 10 and the device 20 according to the present embodiment do not necessarily need to be processed in time series in the order described as the explanatory diagrams. For example, each step in the processing of the operation of the server 10 and the device 20 may be processed in an order different from the order described as the explanatory diagrams, or may be processed in parallel.

Furthermore, it is also possible to create one or more computer programs for causing hardware such as a CPU, a ROM, and a RAM built in the server 10 and the device 20 described above to exhibit the functions of the information processing system according to the present embodiment. Furthermore, a computer-readable storage medium that stores the one or more computer programs is also provided.

Furthermore, the effects described in the present specification are merely exemplary or illustrative, and not restrictive. That is, the technology according to the present disclosure can exhibit other effects apparent to those skilled in the art from the description of the present specification, in addition to the effects described above or instead of the effects described above.

Note that the following configurations also fall within the technological scope of the present disclosure.
(1)

An information processing device including:
an acquisition unit configured to acquire position information of a user terminal estimated on the basis of sensing data acquired by the user terminal used by a user and a content operation history of the user recognized by an action recognition unit; and
a position information correction unit configured to correct the estimated position information of the user terminal on the basis of position information of the user terminal and the content operation history of the user.
(2)

The information processing device according to (1), in which
the content operation history includes content identification information that enables unique identification of, among a plurality of pieces of content, the content on which the user has performed an operation, and
the position information correction unit is configured to correct the position information of the user terminal on the basis of first coordinates associated with the content identification information in a storage unit.
(3)

The information processing device according to (2), in which
the position information correction unit is configured to correct the position information of the user terminal on the basis of the first coordinates associated with content identification information of the content operated by the user and first reliability information associated with the content identification information, and
the first reliability information is information indicating a size of a range having the first coordinates as a starting point and in which the user who has operated the content is estimated to be located.
(4)

The information processing device according to (3), in which
the sensing data includes an acceleration and an angular velocity acquired by the user terminal,
the position information of the user terminal includes second coordinates indicating coordinates of an estimated position of the user terminal and second reliability information indicating a size of an error range that is possibly included in the estimated position of the user terminal, and
the position information correction unit is configured to correct the second coordinates and the second reliability information on the basis of the first coordinates and the first reliability information.
(5)

The information processing device according to (4), in which
the position information includes an estimated traveling speed of the user and an estimated traveling direction of the user, and
the position information correction unit is configured to correct the second coordinates, the estimated traveling speed, the estimated traveling direction, and the second reliability on the basis of the first coordinates and the first reliability information.
(6)

The information processing device according to any one of (3) to (5), in which
the position information correction unit is configured to, in response to recognizing that the user has performed an operation on the content, correct the position information of the user terminal using the first coordinates and the first reliability information associated with the content identification information of the content.
(7)

The information processing device according to any one of (2) to (6), further including:
a generation unit configured to
generate a list screen of the content that is a list of the plurality of pieces of the content displayed on the user terminal, and
determine a display position or a display order of the content on the list screen on the basis of the position information of the user terminal before correction.
(8)

The information processing device according to (7), in which
the generation unit is configured to, in response to the position information correction unit correcting the position information of the user terminal, update a display position or a display order of the content on the basis of the corrected position information of the user terminal.
(9)

The information processing device according to (7) or (8), in which
the generation unit is configured to determine a display position or a display order of the content such that the content is displayed in order of increasing distance between the first coordinates associated with the content and the position information of the user terminal.
(10)

The information processing device according to any one of (7) to (9), in which
the generation unit is configured to determine and update a display position or a display order of the content according to an order preset for each of the plurality of pieces of content.
(11)

The information processing device according to any one of (7) to (10), in which
the position information includes an estimated traveling direction of the user terminal, and
the generation unit is configured to determine a display position or a display order of the content such that content associated with coordinates located on the estimated traveling direction side of the user terminal is displayed higher than content associated with coordinates located on an opposite side of the estimated traveling direction of the user terminal.
(12)

The information processing device according to any one of (4) to (11), in which
the content includes audio content for which the user can perform an operation of playback, stopping, or fast-forwarding, and
the position information correction unit is configured to correct the position information of the user terminal on the basis of the first coordinates associated with the content identification information of the audio content for which an operation of playback, stopping, or fast-forwarding has been performed by the user.
(13)

The information processing device according to (4) to (12), in which
the content operation history includes information indicating that the user who uses the user terminal has operated the user terminal to perform a predetermined action, and
the position information correction unit is configured to correct the position information of the user terminal on the basis of a fact that the user has performed the predetermined action and on the basis of the first coordinates associated with the predetermined action in the storage unit.
(14)

The information processing device according to (4) to (13), further including:
a position estimation unit configured to
learn a relationship among the acceleration, the angular velocity, a traveling speed of the user, and a traveling direction of the user using a neural network that takes, as input data, the acceleration, the angular velocity, correct answer data of walking speed of the user who uses the user terminal, and correct answer data of a traveling direction of the user, and
estimate the position information of the user terminal using a model obtained as a result of learning.
(15)

An information processing method to be executed by a computer, the information processing method including:
acquiring position information of a user terminal estimated on the basis of sensing data acquired by the user terminal used by a user and a content operation history of the user recognized by an action recognition unit; and
correcting the estimated position information of the user terminal on the basis of position information of the user terminal and the content operation history of the user.
(16)

A program that causes a computer to function as:
an acquisition unit configured to acquire position information of a user terminal estimated on the basis of sensing data acquired by the user terminal used by a user and a content operation history of the user recognized by an action recognition unit; and
a position information correction unit configured to correct the estimated position information of the user terminal on the basis of position information of the user terminal and the content operation history of the user.

### REFERENCE SIGNS LIST

10 Server
110 Communication unit
130 Database unit
150 Control unit
20 Device
21 Device
210 Communication unit
230 Storage unit
250 Sensor unit
270 Position estimation unit
290 Control unit
291 Action recognition unit
293 Position information correction unit
295 Generation unit

1. An information processing device comprising:
an acquisition unit configured to acquire position information of a user terminal estimated on a basis of sensing data acquired by the user terminal used by a user and a content operation history of the user recognized by an action recognition unit; and
a position information correction unit configured to correct the estimated position information of the user terminal on a basis of position information of the user terminal and the content operation history of the user.

2. The information processing device according to claim 1, wherein
the content operation history includes content identification information that enables unique identification of, among a plurality of pieces of content, the content on which the user has performed an operation, and
the position information correction unit is configured to correct the position information of the user terminal on a basis of first coordinates associated with the content identification information in a storage unit.

3. The information processing device according to claim 2, wherein
the position information correction unit is configured to correct the position information of the user terminal on a basis of the first coordinates associated with content identification information of the content operated by the user and first reliability information associated with the content identification information, and
the first reliability information is information indicating a size of a range having the first coordinates as a starting point and in which the user who has operated the content is estimated to be located.

4. The information processing device according to claim 3, wherein
the sensing data includes an acceleration and an angular velocity acquired by the user terminal,
the position information of the user terminal includes second coordinates indicating coordinates of an estimated position of the user terminal and second reliability information indicating a size of an error range that is possibly included in the estimated position of the user terminal, and
the position information correction unit is configured to correct the second coordinates and the second reliability information on a basis of the first coordinates and the first reliability information.

5. The information processing device according to claim 4, wherein
the position information includes an estimated traveling speed of the user and an estimated traveling direction of the user, and
the position information correction unit is configured to correct the second coordinates, the estimated traveling speed, the estimated traveling direction, and the second reliability on a basis of the first coordinates and the first reliability information.

6. The information processing device according to claim 5, wherein
the position information correction unit is configured to, in response to recognizing that the user has performed an operation on the content, correct the position information of the user terminal using the first coordinates and the first reliability information associated with the content identification information of the content.

7. The information processing device according to claim 4, further comprising:
a generation unit configured to
generate a list screen of the content that is a list of the plurality of pieces of the content displayed on the user terminal, and
determine a display position or a display order of the content on the list screen on a basis of the position information of the user terminal before correction.

8. The information processing device according to claim 7, wherein
the generation unit is configured to, in response to the position information correction unit correcting the position information of the user terminal, update a display position or a display order of the content on a basis of the corrected position information of the user terminal.

9. The information processing device according to claim 8, wherein
the generation unit is configured to determine a display position or a display order of the content such that the content is displayed in order of increasing distance between the first coordinates associated with the content and the position information of the user terminal.

10. The information processing device according to claim 9, wherein
the generation unit is configured to determine and update a display position or a display order of the content according to an order preset for each of the plurality of pieces of content.

11. The information processing device according to claim 9, wherein
the position information includes an estimated traveling direction of the user terminal, and
the generation unit is configured to determine a display position or a display order of the content such that content associated with coordinates located on the estimated traveling direction side of the user terminal is displayed higher than content associated with coordinates located on an opposite side of the estimated traveling direction of the user terminal.

12. The information processing device according to claim 4, wherein
the content includes audio content for which the user can perform an operation of playback, stopping, or fast-forwarding, and
the position information correction unit is configured to correct the position information of the user terminal on a basis of the first coordinates associated with the content identification information of the audio content for which an operation of playback, stopping, or fast-forwarding has been performed by the user.

13. The information processing device according to claim 4, wherein
the content operation history includes information indicating that the user who uses the user terminal has operated the user terminal to perform a predetermined action, and
the position information correction unit is configured to correct the position information of the user terminal on a basis of a fact that the user has performed the predetermined action and on a basis of the first coordinates associated with the predetermined action in the storage unit.

14. The information processing device according to claim 4, further comprising:
a position estimation unit configured to
learn a relationship among the acceleration, the angular velocity, a traveling speed of the user, and a traveling direction of the user using a neural network that takes, as input data, the acceleration, the angular velocity, correct answer data of walking speed of the user who uses the user terminal, and correct answer data of a traveling direction of the user, and
estimate the position information of the user terminal using a model obtained as a result of learning.

15. An information processing method to be executed by a computer, the information processing method comprising:
acquiring position information of a user terminal estimated on a basis of sensing data acquired by the user terminal used by a user and a content operation history of the user recognized by an action recognition unit; and
correcting the estimated position information of the user terminal on a basis of position information of the user terminal and the content operation history of the user.

16. A program that causes a computer to function as:
an acquisition unit configured to acquire position information of a user terminal estimated on a basis of sensing data acquired by the user terminal used by a user and a content operation history of the user recognized by an action recognition unit; and
a position information correction unit configured to correct the estimated position information of the user terminal on a basis of position information of the user terminal and the content operation history of the user.
